(19) United States
(12) Patent Application Publication
(10) Pub. No.: US 2017/0013500 A1
(43) Pub. Date: Jan. 12, 2017

(54) RADIO ACCESS NETWORK DEVICE, USER EQUIPMENT, AND METHOD FOR REPORTING STATUS OF BUFFER

(71) Applicant: Huawei Technologies Co., Ltd., Shenzhen (CN)

(72) Inventors: Li JI, Shenzhen (CN); Li YANG, Shenzhen (CN)

(21) Appl. No.: 15/274,556

(22) Filed: Sep. 23, 2016

Related U.S. Application Data
(63) Continuation of application No. PCT/CN2014/073962, filed on Mar. 24, 2014.

(51) Int. Cl. H04W 28/02; H04W 24/10; H04W 28/22

(52) U.S. Cl. CPC H04W 28/0278; H04W 28/22; H04W 28/0205; H04W 24/10; H04W 88/02

(57) ABSTRACT

The present invention provides a radio access network device, a user equipment, and a method for reporting status of a buffer. The method includes: determining whether a rate at which a user equipment receives service data is lower than a rate at which the user equipment plays service data; increasing resource for receiving downlink service data for the user equipment if it is determined that the rate at which the user equipment receives service data is lower than the rate at which the user equipment plays service data. The present invention solves the problem of service interruption caused when all the service data cached in the buffer is consumed due to that the rate at which the user equipment receives service data is lower than the rate at which the user equipment plays service data after network environment changes, thereby guaranteeing the continuity of the service.

### CROSS-REFERENCE TO RELATED APPLICATIONS

This application is a continuation of International Application No. PCT/CN2014/073962, filed on Mar. 24, 2014, the disclosure of which is hereby incorporated by reference in its entirety.

### TECHNICAL FIELD

The present invention relates to the field of communication technologies and, in particular, to a radio access network device, a user equipment, and a method for reporting status of buffer.

### BACKGROUND

In a communication system, a radio access network (RAN) device transmits service data to a user equipment (UE) via an air interface. Because of signal fluctuation on the air interface and controls provided by kinds of RAN equipment algorithm, the rate at which the UE receives the service data may be unstable (for example, video interruption, webpage disfluency and etc.). The problem of service experience decreasing caused by possibly unstable rate at which the UE receives service data can be solved by using buffering technology. However, in the circumstance that the network environment changes, for example, signal quality becomes worse or even a connection between the UE and the RAN equipment breaks, the rate at which the UE plays service data may be higher than the rate at which the UE receives service data, thus the service data cached in the buffer of the UE will be consumed, and then lead to an interruption of current service.

### SUMMARY

Embodiments of the present invention provide a radio access network device, a user equipment, and a method for reporting status of a buffer, for solving the problem of service interruption caused when all data amount cached in a buffer is consumed.

In a first aspect, embodiments of the present invention provide a radio access network device, including:

a first processor, configured to determine whether a rate at which a user equipment receives service data is lower than a rate at which the user equipment plays service data;

a second processor, configured to, if it is determined that the rate at which the user equipment receives service data is lower than the rate at which the user equipment plays service data, increase resource for receiving downlink service data for the user equipment, so that the rate at which the user equipment receives service data is not lower than the rate at which the user equipment plays service data.

In a first possible implementation of the first aspect, the second processor is further configured to, in a circumstance that left amount of data cached in a buffer is less than or equal to a first threshold value or time length for playing left amount of data cached in a buffer is less than or equal to a second threshold value, increase resource for receiving downlink service data for the user equipment, so that the rate at which the user equipment receives service data is not lower than the rate at which the user equipment plays service data.

With reference to the first aspect or the first possible implementation of the first aspect, in a second possible implementation, the second processor is specifically configured to increase the resource for receiving downlink service data for the user equipment by increasing resource of a source serving cell of the user equipment, so that the rate at which the user equipment receives service data is not lower than the rate at which the user equipment plays service data; or, specifically configured to increase the resource for receiving downlink service data for the user equipment by switching the user equipment from a source serving cell to a target cell, so that the rate at which the user equipment receives service data is not lower than the rate at which the user equipment plays service data.

With reference to the first or the second possible implementation, in a third possible implementation, further including:

a transmitter, configured to transmit configuration information to the user equipment before increasing the resource for receiving downlink service data for the user equipment, where the configuration information is used for indicating manner information of reporting the left amount of the data cached in the buffer or the time length for playing the left amount of the data cached in the buffer by the user equipment; and;

a receiver, configured to receive response information transmitted by the user equipment, where the response information is used for indicating the left amount of the data cached in the buffer or the time length for playing the left amount of the data cached in the buffer, which is reported by the user equipment.

With reference to the third possible implementation of the first aspect, in a fourth possible implementation, the manner information is period information, threshold value information, or indication information,

where the period information is used for indicating a period at which the user equipment reports the left amount of the data cached in the buffer or the time length for playing the left amount of the data cached in the buffer to the radio access network device, the threshold value information represents a first threshold value or a second threshold value, so that the user equipment determines to report the left amount of the data cached in the buffer to the radio access network device when the left amount of the data cached in the buffer is less than or equal to the first threshold value, or determines to report the left amount of the data cached in the buffer to the radio access network device when the time length for playing the left amount of the data cached in the buffer is less than or equal to the second threshold value, the indication information is used for indicating the user equipment to report the left amount of the data cached in the buffer or the time length for playing the left amount of the data cached in the buffer to the radio access network device.

With reference to the third or fourth possible implementation of the first aspect, in a fifth possible implementation, the configuration information is radio resource control connection re-configuration information, the response information is measurement report information.

In a second aspect, embodiments of the present invention provide a user equipment, including:

a receiver, configured to receive configuration information transmitted by a radio access network device, where the configuration information is used for indicating manner information of reporting left amount of data cached in a buffer or time length for playing left amount of data cached in a buffer to the radio access network device by the user equipment;

a transmitter, configured to transmit response information to the radio access network device according to the received configuration information, where the response information is used for indicating the left amount of the data cached in the buffer or the time length for playing the left amount of the data cached in the buffer, which is reported by the user equipment.

In a first possible implementation of the second aspect, the manner information is period information, threshold value information, or indication information, where, the period information is used for indicating a period at which the user equipment reports the left amount of the data cached in the buffer or the time length for playing the left amount of the data cached in the buffer to the radio access network device, the threshold value information represents a first threshold value or a second threshold value, so that the user equipment determines to report the left amount of the data cached in the buffer to the radio access network device when the left amount of the data cached in the buffer is less than or equal to the first threshold value, or determines to report the left amount of the data cached in the buffer to the radio access network device when the time length for playing the left amount of the data cached in the buffer is less than or equal to the second threshold value, the indication information is used for indicating the user equipment to report the left amount of the data cached in the buffer or the time length for playing the left amount of the data cached in the buffer to the radio access network device.

With reference to the first possible implementation of the second aspect, in a second possible implementation, the transmitter is specifically configured to periodically transmit the response information to the radio access network device according to the period information included in the received configuration information.

With reference to the first possible implementation of the second aspect, in a third possible implementation, the transmitter is specifically configured to transmit the response information to the radio access network device when the left amount of data cached in the buffer is less than or equal to the first threshold value or the time length for playing the left amount of data cached in the buffer is less than or equal to the second threshold value.

With reference to the first possible implementation of the second aspect, in a fourth possible implementation, the transmitter is specifically configured to transmit the response information to the radio access network device according to the indication information included in the received configuration information.

With reference to any one of the second aspect, the first to fourth possible implementation of the second aspect, in a fifth possible implementation, the configuration information is radio resource control connection re-configuration information, the response information is measurement report information.

In a third aspect, embodiments of the present invention provide a method for reporting status of a buffer, including:

determining, by a radio access network device, whether a rate at which a user equipment receives service data is lower than a rate at which the user equipment plays service data;

increasing, by the radio access network device, resource for receiving downlink service data for the user equipment if it is determined that the rate at which the user equipment receives service data is lower than the rate at which the user equipment plays service data, so that the rate at which the user equipment receives service data is not lower than the rate at which the user equipment plays service data.

In a first possible implementation of the third aspect, further including:

in a circumstance that left amount of data cached in a buffer is less than or equal to a first threshold value or time length for playing left amount of data cached in a buffer is less than or equal to a second threshold value, increasing, by the radio access network device, resource for receiving downlink service data for the user equipment, so that the rate at which the user equipment receives service data is not lower than the rate at which the user equipment plays service data.

With reference to the third aspect or the first possible implementation of the third aspect, in a second possible implementation, the increasing, by the radio access network device, the resource for receiving downlink service data for the user equipment, so that the rate at which the user equipment receives service data is not lower than the rate at which the user equipment plays service data, includes:

increasing, by the radio access network device, the resource for receiving downlink service data for the user equipment by increasing resource of a source serving cell of the user equipment, so that the rate at which the user equipment receives service data is not lower than the rate at which the user equipment plays service data; or

increasing, by the radio access network device, the resource for receiving downlink service data for the user equipment by switching the user equipment from a source serving cell to a target cell, so that the rate at which the user equipment receives service data is not lower than the rate at which the user equipment plays service data.

With reference to the first or second implementation of the third aspect, in a third possible implementation, before the increasing, by the radio access network device, the resource for receiving downlink service data for the user equipment, further including:

transmitting, by the radio access network device, configuration information to the user equipment, where the configuration information is used for indicating manner information of reporting left amount of data cached in a buffer or time length for playing left amount of data cached in a buffer by the user equipment;

receiving, by the radio access network device, response information transmitted by the user equipment, where the response information is used for indicating the left amount of the data cached in the buffer or the time length for playing the left amount of the data cached in the buffer, which is reported by the user equipment.

With reference to the third possible implementation of the third aspect, in a fourth possible implementation, the manner information is period information, threshold value information, or indication information,

where, the period information is used for indicating a period at which the user equipment reports the left amount of the data cached in the buffer or the time length for playing the left amount of the data cached in the buffer to the radio access network device, the threshold value information represents a first threshold value or a second threshold value, so that the user equipment determines to report the left amount of the data cached in the buffer to the radio access network device when the left amount of the data cached in the buffer is less than or equal to the first threshold value, or determines to report the left amount of the data cached in the buffer to the radio access network device when the time length for playing the left amount of the data cached in the buffer is less than or equal to the second threshold value, the indication information is used for indicating the user equipment to report the left amount of the data cached in the buffer or the time length for playing the left amount of the data cached in the buffer to the radio access network device.

With reference to the third or fourth possible implementation of the third aspect, in a fifth possible implementation, the configuration information is radio resource control connection re-configuration information, the response information is measurement report information.

In a fourth aspect, embodiments of the present invention provide a method for reporting status of a buffer, including:

receiving, by a user equipment, configuration information transmitted by a radio access network device, where the configuration information is used for indicating manner information of reporting left amount of data cached in a buffer or time length for playing left amount of data cached in a buffer to the radio access network device by the user equipment;

transmitting, by the user equipment, response information to the radio access network device according to the received configuration information, where the response information is used for indicating the left amount of the data cached in the buffer or the time length for playing the left amount of the data cached in the buffer reported by the user equipment.

In a first possible implementation of the fourth aspect, the manner information is period information, threshold value information, or indication information, where the period information is used for indicating a period at which the user equipment reports the left amount of the data cached in the buffer or the time length for playing the left amount of the data cached in the buffer to the radio access network device, the threshold value information represents a first threshold value or a second threshold value, so that the user equipment determines to report the left amount of the data cached in the buffer to the radio access network device when the left amount of the data cached in the buffer is less than or equal to the first threshold value, or determines to report the left amount of the data cached in the buffer to the radio access network device when the time length for playing the left amount of the data cached in the buffer is less than or equal to the second threshold value, the indication information is used for indicating the user equipment to report the left amount of the data cached in the buffer or the time length for playing the left amount of the data cached in the buffer to the radio access network device.

With reference to the first possible implementation, in a second possible implementation, the transmitting, by the user equipment, the response information to the radio access network device according to the received configuration information, includes:

periodically transmitting, by the user equipment, the response information to the radio access network device according to the period information included in the received configuration information.

With reference to the first possible implementation, in a third possible implementation, where the transmitting, by the user equipment, the response information to the radio access network device according to the received configuration information, includes:

transmitting, by the user equipment, the response information to the radio access network equipment when the left amount of the data cached in the buffer is less than or equal to the first threshold value or the time length for playing the left amount of the data cached in the buffer is less than or equal to the second threshold value.

With reference to the first possible implementation, in a fourth possible implementation, the transmitting, by the user equipment, the response information to the radio access network device according to the received configuration information, includes:

transmitting, by the user equipment, the response information to the radio access network device according to the indication information included in the received configuration information.

With reference to any one of the fourth aspect, the first to the fourth possible implementations, in a fifth possible implementation, the configuration information is radio resource control connection re-configuration information, the response information is measurement report information.

According to the radio access network device, the user equipment and the method for reporting status of a buffer provided by embodiments of the present invention, when it is determined that the rate at which the user equipment receives service data is lower than the rate at which the user equipment plays service data, increase resource for receiving downlink service data for the user equipment, so that the rate at which the user equipment receives service data is not lower than the rate at which the user equipment plays service data, thus solves the problem of service interruption caused when all the service data cached in the buffer is consumed due to that the rate at which the user equipment receives service data is lower than the rate at which the user equipment plays service data after network environment changes, thereby guaranteeing the continuity of the service.

### BRIEF DESCRIPTION OF DRAWINGS

To describe the technical solutions in embodiments of the present invention more clearly, the following briefly introduces the accompanying drawings needed for describing the embodiments. Apparently, the accompanying drawings in the following description illustrate merely some embodiments of the present invention, and persons of ordinary skill in the art may still derive other drawings from these accompanying drawings without creative effort.

FIG. 1 is a schematic diagram of a radio access network device 100 according to a first embodiment of the present invention;

FIG. 2 is a schematic diagram of a user equipment 200 according to a second embodiment of the present invention;

FIG. 3 is a schematic flowchart of a method for reporting status of a buffer according to a third embodiment of the present invention;

FIG. 4 is a schematic flowchart of a method for reporting status of a buffer according to a fourth embodiment of the present invention;

FIG. 5 is a schematic flowchart of a method for reporting status of a buffer according to a fifth embodiment of the present invention;

FIG. 6 is a schematic flowchart of a method for reporting status of a buffer according to a sixth embodiment of the present invention;

FIG. 7 is a schematic flowchart of a method for reporting status of a buffer according to a seventh embodiment of the present invention;

FIG. 8 is a schematic flowchart of a method for reporting status of a buffer according to an eighth embodiment of the present invention.

### DESCRIPTION OF EMBODIMENTS

To make the objectives, technical solutions, and advantages of embodiments of the present invention more clearly, The following clearly and comprehensively describes the technical solutions in embodiments of the present invention with reference to the accompanying drawings in embodiments of the present invention. It is evident that the embodiments are merely some exemplary embodiments of the present invention, and the present invention is not limited to such embodiments. All other embodiments obtained by those skilled in the art based on embodiments of the present invention shall all fall within the protection scope of the present invention.

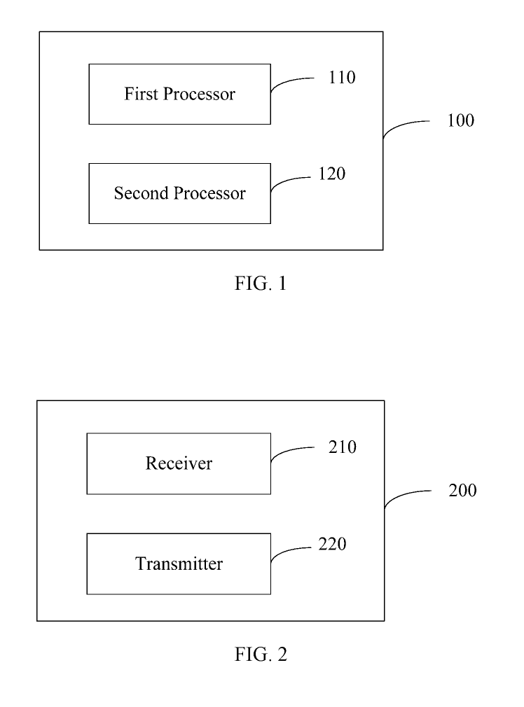

FIG. 1 is a schematic diagram of a radio access network device 100 according to a first embodiment of the present invention. Referring to FIG. 1, the radio access network equipment includes: a first processor 110 and a second processor 120.

The first processor 110 is configured to determine whether a rate at which a user equipment receives service data is lower than a rate at which the user equipment plays service data. The second processor 120 is configured to, if it is determined that the rate at which the user equipment receives service data is lower than the rate at which the user equipment plays service data, increase resource for receiving downlink service data for the user equipment, so that the rate at which the user equipment receives service data is not lower than the rate at which the user equipment plays service data.

According to the radio access network device provided by this embodiment, when it is determined that the rate at which the user equipment receives service data is lower than the rate at which the user equipment plays service data, increase resource for receiving downlink service data for the user equipment, so that the rate at which the user equipment receives service data is not lower than the rate at which the user equipment plays service data, thus solves the problem of service interruption caused when all the service data cached in the buffer is consumed due to that the rate at which the user equipment receives service data is lower than the rate at which the user equipment plays service data after network environment changes, thereby guaranteeing the continuity of the service.

Further, the second processor 120 is also configured to, in a circumstance that left amount of data cached in the buffer is less than or equal to a first threshold value or time length for playing left amount of data cached in the buffer is less than or equal to a second threshold value, increase resource for receiving downlink service data for the user equipment, so that the rate at which the user equipment receives service data is not lower than the rate at which the user equipment plays service data.

Further, the second processor 120 is specifically configured to increase the resource for receiving downlink service data for the user equipment by increasing resource of a source serving cell of the user equipment, so that the rate at which the user equipment receives service data is not lower than the rate at which the user equipment plays service data; or, specifically configured to increase the resource for receiving downlink service data for the user equipment by switching the user equipment from a source serving cell to a target cell, so that the rate at which the user equipment receives service data is not lower than the rate at which the user equipment plays service data.

Further, the radio access network equipment also includes:

a transmitter, configured to transmit configuration information to the user equipment before increasing the resource for receiving downlink service data for the user equipment, where the configuration information is used for indicating manner information of reporting the left amount of the data cached in the buffer or the time length for playing the left amount of the data cached in the buffer by the user equipment; and

a receiver, configured to receive response information transmitted by the user equipment, where the response information is used for indicating the left amount of the data cached in the buffer or the time length for playing the left amount of the data cached in the buffer, which is reported by the user equipment.

Further, the manner information is period information, threshold value information, or indication information,

where, the period information is used for indicating a period at which the user equipment reports the left amount of the data cached in the buffer or the time length for playing the left amount of the data cached in the buffer to the radio access network device, the threshold value information represents a first threshold value or a second threshold value, so that the user equipment determines to report the left amount of the data cached in the buffer to the radio access network device when the left amount of the data cached in the buffer is less than or equal to the first threshold value, or determines to report the left amount of the data cached in the buffer to the radio access network device when the time length for playing the left amount of the data cached in the buffer is less than or equal to the second threshold value; the indication information is used for indicating the user equipment to report the left amount of the data cached in the buffer or the time length for playing the left amount of the data cached in the buffer to the radio access network device.

Further, the configuration information is radio resource control connection re-configuration information, the response information is measurement report information.

FIG. 2 is a schematic diagram of a user equipment 200 according to a second embodiment of the present invention. Referring to FIG. 2, the user equipment includes: a receiver 210 and a transmitter 220.

The receiver 210 is configured to receive configuration information transmitted by a radio access network device, where the configuration information is used for indicating manner information of reporting left amount of data cached in a buffer or time length for playing left amount of data cached in a buffer to the radio access network device by the user equipment; the transmitter 220 is configured to transmit response information to the radio access network device according to the received configuration information, where the response information is used for indicating the left amount of the data cached in the buffer or the time length for playing the left amount of the data cached in the buffer, which is reported by the user equipment.

The user equipment provided by this embodiment, receives configuration information transmitted by a radio access network device, and transmits response information to the radio access network device according to the received configuration information, to indicate left amount of data cached in the buffer or time length for playing left amount of data cached in the buffer reported by the user equipment, so as to enable the radio access network equipment to increase resource for receiving downlink service data for the user equipment according to the left amount of the data cached in the buffer or the time length for playing the left amount of the data cached in the buffer, so that the rate at which the user equipment receives service data is not lower than the rate at which the user equipment plays service data, thereby solving the problem of service interruption caused when all the service data cached in the buffer is consumed due to that the rate at which the user equipment receives service data is lower than the rate at which the user equipment plays service data after network environment changes, and thus the continuity of the service is ensured.

Further, the manner information is period information, threshold value information, or indication information, where, the period information is used for indicating a period at which the user equipment reports the left amount of the data cached in the buffer or the time length for playing the left amount of the data cached in the buffer to the radio access network device, the threshold value information represents a first threshold value or a second threshold value, so that the user equipment determines to report the left amount of the data cached in the buffer to the radio access network device when the left amount of the data cached in the buffer is less than or equal to the first threshold value, or determines to report the left amount of the data cached in the buffer to the radio access network device when the time length for playing the left amount of the data cached in the buffer is less than or equal to the second threshold value; the indication information is used for indicating the user equipment to report the left amount of the data cached in the buffer or the time length for playing the left amount of the data cached in the buffer to the radio access network device.

Further, the transmitter 220 is specifically configured to periodically transmit the response information to the radio access network device according to the period information included in the received configuration information.

Optionally, the transmitter 220 is specifically configured to transmit the response information to the radio access network device when left amount of data cached in the buffer is less than or equal to a first threshold value or time length for playing left amount of data cached in the buffer is less than or equal to a second threshold value.

Optionally, the transmitter 220 is specifically configured to transmit the response information to the radio access network device according to the indication information included in the received configuration information.

Further, the configuration information is radio resource control connection re-configuration information, the response information is measurement report information.

Further, the radio access network device is an evolved base station, a radio network controller, or a base station controller.

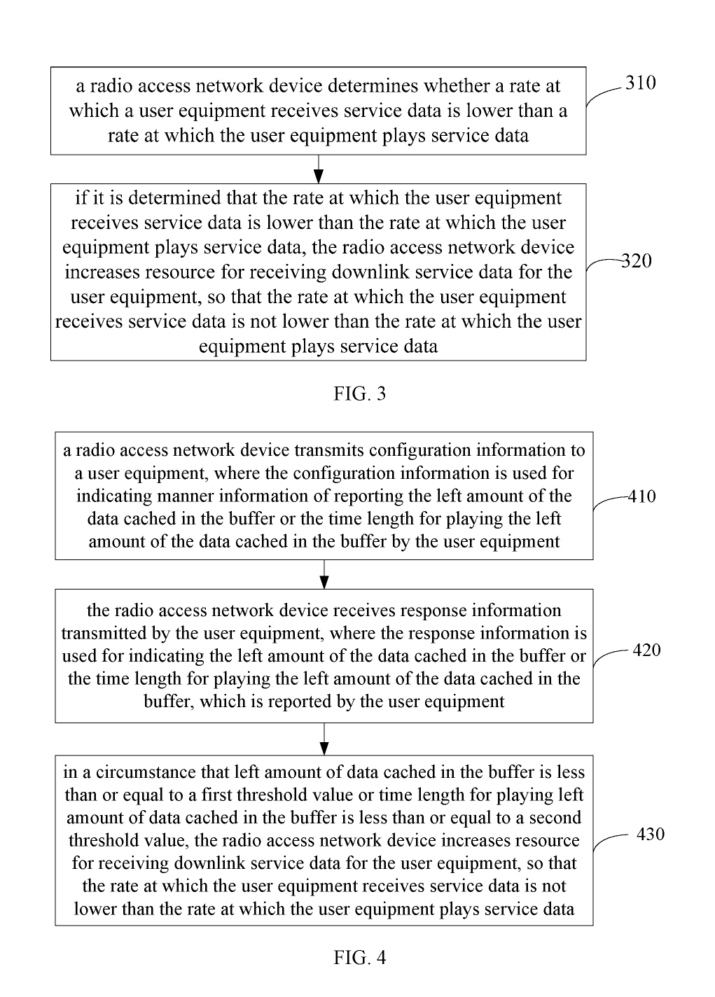

FIG. 3 is a schematic flowchart of a method for reporting status of a buffer according to a third embodiment of the present invention. The method of this embodiment is applied to a circumstance that a radio access network equipment increases resource for receiving downlink service data for the user equipment after network environment changes, to ensure the rate at which the user equipment receives service data is not lower than the rate at which the user equipment plays service data. The method is executed by a radio access network device, where the radio access network device is generally implemented by means of hardware and/or software. The method of this embodiment includes following steps:

310, a radio access network device determines whether a rate at which a user equipment receives service data is lower than a rate at which the user equipment plays service data;

320, if it is determined that the rate at which the user equipment receives service data is lower than the rate at which the user equipment plays service data, the radio access network device increases resource for receiving downlink service data for the user equipment, so that the rate at which the user equipment receives service data is not lower than the rate at which the user equipment plays service data.

In the prior art, since the radio access network device cannot know left amount of data cached in a buffer at the user equipment side after transmitting service data to the user equipment, and meanwhile because of a change of the network environment, a circumstance that the rate at which the UE plays service data is higher than the rate at which the UE receives service data may exist, thus a service interruption will occur after the service data cached in the buffer of the UE is consumed. According to the embodiment, determine whether a rate at which a user equipment receives service data is lower than a rate at which the user equipment plays service data, and when it is determined that the rate at which the user equipment receives service data is lower than the rate at which the user equipment plays service data, increase resource for receiving downlink service data for the user equipment, so that the rate at which the user equipment receives service data is not lower than the rate at which the user equipment plays service data, thus solves the problem of service interruption caused when all the service data cached in the buffer is consumed due to that the rate at which the user equipment receives service data is lower than the rate at which the user equipment plays service data after network environment changes, thereby guaranteeing the continuity of the service.

According to the method for reporting status of a buffer, determine whether a rate at which a user equipment receives service data is lower than a rate at which the user equipment plays service data, and when it is determined that the rate at which the user equipment receives service data is lower than the rate at which the user equipment plays service data, increase resource for receiving downlink service data for the user equipment, so that the rate at which the user equipment receives service data is not lower than the rate at which the user equipment plays service data, thus solves the problem of service interruption caused when all the service data cached in the buffer is consumed due to that the rate at which the user equipment receives service data is lower than the rate at which the user equipment plays service data after network environment changes, thereby guaranteeing the continuity of the service.

FIG. 4 is a schematic flowchart of a method for reporting status of a buffer according to a fourth embodiment of the present invention. Referring to FIG. 4, the method of this embodiment may include:

410, a radio access network device transmits configuration information to a user equipment, where the configuration information is used for indicating manner information of reporting the left amount of the data cached in the buffer or the time length for playing the left amount of the data cached in the buffer by the user equipment.

Where, the configuration information may be radio resource control connection re-configuration RRC Connection Reconfiguration information, the manner information may be period information, threshold value information, or indication information. Where, the period information is used for indicating a period at which the user equipment reports the left amount of the data cached in the buffer or the time length for playing the left amount of the data cached in the buffer to the radio access network device, the threshold value information represents a first threshold value or a second threshold value, so that the user equipment determines to report the left amount of the data cached in the buffer to the radio access network device when the left amount of the data cached in the buffer is less than or equal to the first threshold value, or determines to report the left amount of the data cached in the buffer to the radio access network device when the time length for playing the left amount of the data cached in the buffer is less than or equal to the second threshold value; the indication information is used for indicating the user equipment to report the left amount of the data cached in the buffer or the time length for playing the left amount of the data cached in the buffer to the radio access network device.

420, the radio access network device receives response information transmitted by the user equipment, where the response information is used for indicating the left amount of the data cached in the buffer or the time length for playing the left amount of the data cached in the buffer, which is reported by the user equipment.

Specifically, the response information may be measurement report information.

430, in a circumstance that left amount of data cached in the buffer is less than or equal to a first threshold value or time length for playing left amount of data cached in the buffer is less than or equal to a second threshold value, the radio access network device increases resource for receiving downlink service data for the user equipment, so that the rate at which the user equipment receives service data is not lower than the rate at which the user equipment plays service data.

For example, the increasing the resource for receiving downlink service data for the user equipment by the radio access network equipment may be implemented through following manners:

The radio access network device increases the resource for receiving downlink service data for the user equipment by increasing resource of a source serving cell of the user equipment, so that the rate at which the user equipment receives service data is not lower than the rate at which the user equipment plays service data; or

The radio access network device increases the resource for receiving downlink service data for the user equipment by switching the user equipment from a source serving cell to a target cell, so that the rate at which the user equipment receives service data is not lower than the rate at which the user equipment plays service data.

The radio access network device receives response information transmitted by the user equipment, thus the radio access network is capable of determining whether the left amount of data cached in the buffer is less than or equal to the first threshold value or determining whether the time length for playing left amount of data cached in the buffer is less than or equal to a second threshold value according to the left amount of the data cached in the buffer or the time length for playing the left amount of the data cached in the buffer which is reported by the user equipment as indicated by the response information; and in a circumstance that the left amount of data cached in the buffer is less than or equal to the first threshold value or the time length for playing the left amount of data cached in the buffer is less than or equal to the second threshold value, increases resource for receiving downlink service data for the user equipment, so that the rate at which the user equipment receives service data is not lower than the rate at which the user equipment plays service data, thereby guaranteeing the continuity of the service.

It needs to be noted that, in steps 410 to 430, the RAN device may be an evolved base station (eNodeB), a radio network controller, or a base station controller.

According to the method for reporting status of a buffer provided by this embodiment, a radio access network device transmits configuration information to a user equipment and receives response information transmitted by the user equipment, and in a circumstance that, as indicated by the response information, the left amount of data cached in the buffer is less than or equal to the first threshold value or the time length for playing the left amount of data cached in the buffer is less than or equal to the second threshold value, the radio access network device increases resource for receiving downlink service data for the user equipment, so that the rate at which the user equipment receives service data is not lower than the rate at which the user equipment plays service data, thus solves the problem of service interruption caused when all the service data cached in the buffer is consumed due to that the rate at which the user equipment receives service data is lower than the rate at which the user equipment plays service data after network environment changes, thereby guaranteeing the continuity of the service.

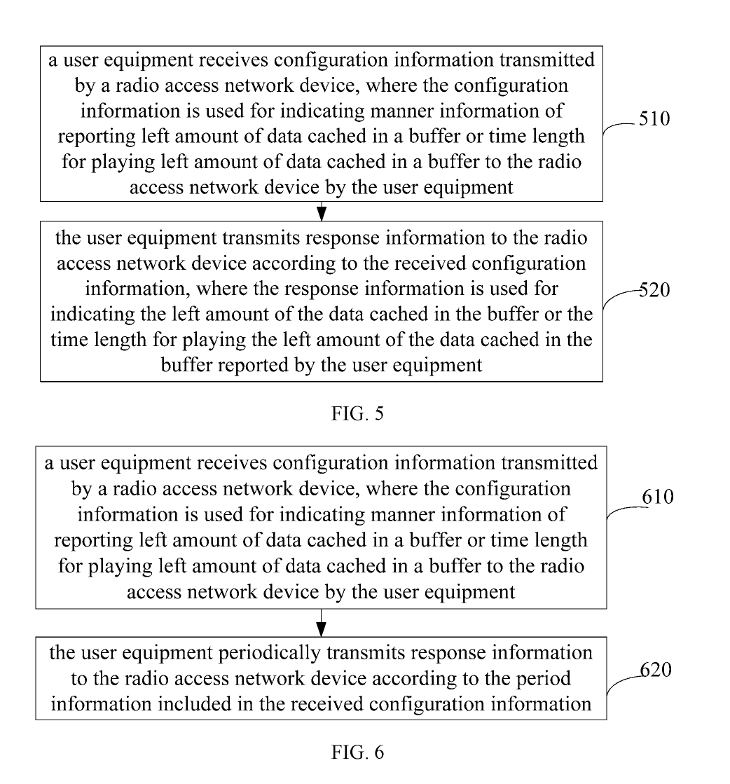

FIG. 5 is a schematic flowchart of a method for reporting status of a buffer according to a fifth embodiment of the present invention. The method of this embodiment is applied to a circumstance that a radio access network equipment increases resource for receiving downlink service data for the user equipment after network environment changes, to ensure the rate at which the user equipment receives service data is not lower than the rate at which the user equipment plays service data. The method is executed by a user equipment, where the user equipment is generally implemented by means of hardware and/or software. The method of this embodiment includes following steps:

510, a user equipment receives configuration information transmitted by a radio access network device, where the configuration information is used for indicating manner information of reporting left amount of data cached in a buffer or time length for playing left amount of data cached in a buffer to the radio access network device by the user equipment.

520, the user equipment transmits response information to the radio access network device according to the received configuration information, where the response information is used for indicating the left amount of the data cached in the buffer or the time length for playing the left amount of the data cached in the buffer reported by the user equipment.

According to the method for reporting status of a buffer, receive configuration information transmitted by a radio access network device, and transmit response information to the radio access network device according to the received configuration information, to indicate left amount of data cached in the buffer or time length for playing left amount of data cached in the buffer reported by the user equipment, so as to enable the radio access network equipment to increase resource for receiving downlink service data for the user equipment according to the left amount of the data cached in the buffer or the time length for playing the left amount of the data cached in the buffer, so that the rate at which the user equipment receives service data is not lower than the rate at which the user equipment plays service data, thereby solving the problem of service interruption caused when all the service data cached in the buffer is consumed due to that the rate at which the user equipment receives service data is lower than the rate at which the user equipment plays service data after network environment changes, and thus the continuity of the service is ensured.

FIG. 6 is a schematic flowchart of a method for reporting status of a buffer according to a sixth embodiment of the present invention. Referring to FIG. 6, the method of this embodiment may include:

610, a user equipment receives configuration information transmitted by a radio access network device, where the configuration information is used for indicating manner information of reporting left amount of data cached in a buffer or time length for playing left amount of data cached in a buffer to the radio access network device by the user equipment.

The configuration information may be radio resource control connection re-configuration information, the manner information may be period information, threshold value information, or indication information. Where, the period information is used for indicating a period at which the user equipment reports the left amount of the data cached in the buffer or the time length for playing the left amount of the data cached in the buffer to the radio access network device, the threshold value information represents a first threshold value or a second threshold value, so that the user equipment determines to report the left amount of the data cached in the buffer to the radio access network device when the left amount of the data cached in the buffer is less than or equal to the first threshold value, or determines to report the left amount of the data cached in the buffer to the radio access network device when the time length for playing the left amount of the data cached in the buffer is less than or equal to the second threshold value; the indication information is used for indicating the user equipment to report the left amount of the data cached in the buffer or the time length for playing the left amount of the data cached in the buffer to the radio access network device.

620, the user equipment periodically transmits response information to the radio access network device according to the period information included in the received configuration information.

According to the method for reporting status of a buffer, receive configuration information transmitted by a radio access network device, where manner information indicated by the configuration information is indication information, and periodically transmit response information to the radio access network device, where the response information is used for indicating left amount of data cached in the buffer or time length for playing left amount of data cached in the buffer periodically reported by the user equipment, so as to enable the radio access network equipment to increase resource for receiving downlink service data for the user equipment according to the left amount of the data cached in the buffer or the time length for playing the left amount of the data cached in the buffer, so that the rate at which the user equipment receives service data is not lower than the rate at which the user equipment plays service data, thereby solving the problem of service interruption caused when all the service data cached in the buffer is consumed due to that the rate at which the user equipment receives service data is lower than the rate at which the user equipment plays service data after network environment changes, and thus the continuity of the service is ensured.

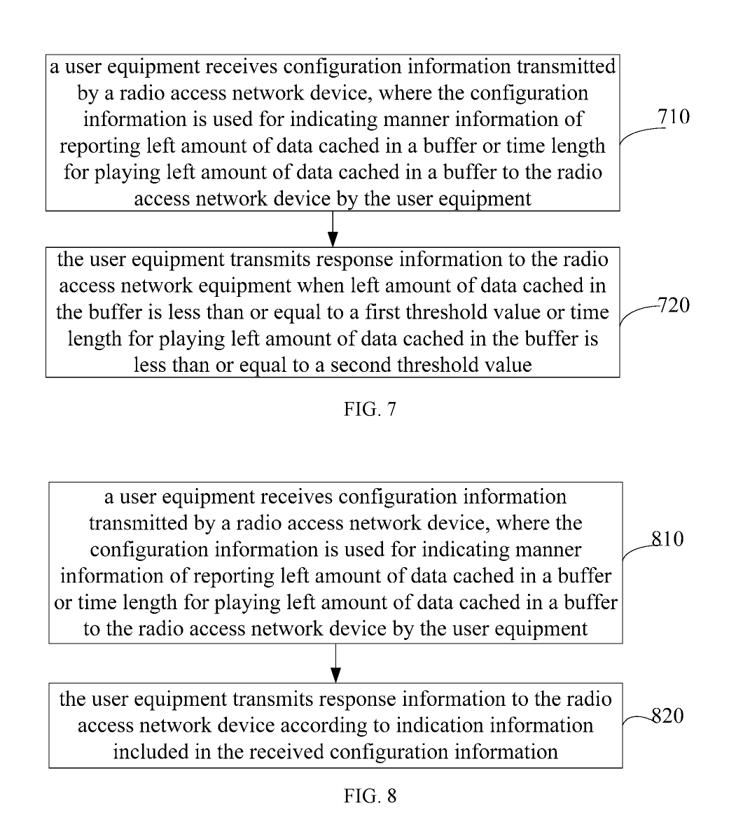

FIG. 7 is a schematic flowchart of a method for reporting status of a buffer according to a seventh embodiment of the present invention. Referring to FIG. 7, the method of this embodiment may include:

710, a user equipment receives configuration information transmitted by a radio access network device, where the configuration information is used for indicating manner information of reporting left amount of data cached in a buffer or time length for playing left amount of data cached in a buffer to the radio access network device by the user equipment.

720, the user equipment transmits response information to the radio access network equipment when left amount of data cached in the buffer is less than or equal to a first threshold value or time length for playing left amount of data cached in the buffer is less than or equal to a second threshold value.

According to the method for reporting status of a buffer, configuration information transmitted by a radio access network device is received, where manner information indicated by the configuration information is a first threshold value or a second threshold value, and response information is transmitted to the radio access network device by a user equipment, when left amount of data cached in the buffer is less than or equal to the first threshold value or time length for playing left amount of data cached in the buffer is less than or equal to the second threshold value. Thus, the radio access network equipment can increase resource for receiving downlink service data for the user equipment according to the left amount of the data cached in the buffer or the time length for playing the left amount of the data cached in the buffer, so that the rate at which the user equipment receives service data is not lower than the rate at which the user equipment plays service data, thereby solving the problem of service interruption caused when all the service data cached in the buffer is consumed due to that the rate at which the user equipment receives service data is lower than the rate at which the user equipment plays service data after network environment changes, and thus the continuity of the service is ensured.

FIG. 8 is a schematic flowchart of a method for reporting status of a buffer according to an eighth embodiment of the present invention. Referring to FIG. 8, the method of this embodiment may includes:

810, a user equipment receives configuration information transmitted by a radio access network device, where the configuration information is used for indicating manner information of reporting left amount of data cached in a buffer or time length for playing left amount of data cached in a buffer to the radio access network device by the user equipment.

820, the user equipment transmits response information to the radio access network device according to indication information included in the received configuration information.

According to the method for reporting status of a buffer, configuration information transmitted by a radio access network device is received, where manner information indicated by the configuration information is indication information, so that the user equipment transmits response information to the radio access network device according to the indication information. Thus, the radio access network equipment can increase resource for receiving downlink service data for the user equipment according to the left amount of the data cached in the buffer or the time length for playing the left amount of the data cached in the buffer, so that the rate at which the user equipment receives service data is not lower than the rate at which the user equipment plays service data, thereby solving the problem of service interruption caused when all the service data cached in the buffer is consumed due to that the rate at which the user equipment receives service data is lower than the rate at which the user equipment plays service data after network environment changes, and thus the continuity of the service is ensured.

Persons of ordinary skill in the art may understand that, all or a part of the steps of the foregoing method embodiments may be implemented by a program instructing relevant hardware. The foregoing program may be stored in a computer readable storage medium. When the program runs, the steps of the foregoing method embodiments are performed. The foregoing storage medium includes various mediums capable of storing program codes, such as an ROM, an RAM, a magnetic disk, or an optical disc.

Finally, it should be noted that the foregoing embodiments are merely intended for describing the technical solutions of the present invention other than limiting the present invention. Although the present invention is described in detail with reference to the foregoing embodiments, a person of ordinary skill in the art should understand that he may still make modifications to the technical solutions described in the foregoing embodiments, or make equivalent replacements to some technical features thereof, without departing from the spirit and scope of the technical solutions of the embodiments of the present invention.

What is claimed is:

1. A radio access network device, comprising:
a first processor, configured to determine whether a rate at which a user equipment receives service data is lower than a rate at which the user equipment plays service data; and
a second processor, configured to, if it is determined that the rate at which the user equipment receives service data is lower than the rate at which the user equipment plays service data, increase resource for receiving downlink service data for the user equipment.

2. The device according to claim 1, wherein the second processor is further configured to, in a circumstance that left amount of data cached in a buffer is less than or equal to a first threshold value or time length for playing left amount of data cached in a buffer is less than or equal to a second threshold value, increase resource for receiving downlink service data for the user equipment.

3. The device according to claim 2, wherein the second processor is configured to increase the resource for receiving downlink service data for the user equipment by increasing resource of a source serving cell of the user equipment; or, configured to increase the resource for receiving downlink service data for the user equipment by switching the user equipment from a source serving cell to a target cell.

4. The device according to claim 2, further comprising:
a transmitter, configured to transmit configuration information to the user equipment before increasing the resource for receiving downlink service data for the user equipment, wherein the configuration information is used for indicating manner information of reporting the left amount of the data cached in the buffer or the time length for playing the left amount of the data cached in the buffer by the user equipment; and
a receiver, configured to receive response information transmitted by the user equipment, wherein the response information is used for indicating the left amount of the data cached in the buffer or the time length for playing the left amount of the data cached in the buffer, which is reported by the user equipment.

5. The device according to claim 4, wherein the manner information is period information, threshold value information, or indication information, wherein, the period information is used for indicating a period at which the user equipment reports the left amount of the data cached in the buffer or the time length for playing the left amount of the data cached in the buffer to the radio access network device, the threshold value information represents a first threshold value or a second threshold value, so that the user equipment determines to report the left amount of the data cached in the buffer to the radio access network device when the left amount of the data cached in the buffer is less than or equal to the first threshold value, or determines to report the left amount of the data cached in the buffer to the radio access network device when the time length for playing the left amount of the data cached in the buffer is less than or equal to the second threshold value, the indication information is used for indicating the user equipment to report the left amount of the data cached in the buffer or the time length for playing the left amount of the data cached in the buffer to the radio access network device.

6. The device according to claim 4, wherein the configuration information is radio resource control connection re-configuration information, the response information is measurement report information.

7. A user equipment, comprising:
a receiver, configured to receive configuration information transmitted by a radio access network device, wherein the configuration information is used for indicating manner information of reporting left amount of data cached in a buffer or time length for playing left amount of data cached in a buffer to the radio access network device by the user equipment; and
a transmitter, configured to transmit response information to the radio access network device according to the received configuration information, wherein the response information is used for indicating the left amount of the data cached in the buffer or the time length for playing the left amount of the data cached in the buffer, which is reported by the user equipment.

8. The equipment according to claim 7, wherein the manner information is period information, threshold value information, or indication information, wherein, the period information is used for indicating a period at which the user equipment reports the left amount of the data cached in the buffer or the time length for playing the left amount of the data cached in the buffer to the radio access network device, the threshold value information represents a first threshold value or a second threshold value, so that the user equipment determines to report the left amount of the data cached in the buffer to the radio access network device when the left amount of the data cached in the buffer is less than or equal to the first threshold value, or determines to report the left amount of the data cached in the buffer to the radio access network device when the time length for playing the left amount of the data cached in the buffer is less than or equal to the second threshold value, the indication information is used for indicating the user equipment to report the left amount of the data cached in the buffer or the time length for playing the left amount of the data cached in the buffer to the radio access network device.

9. The equipment according to claim 8, wherein the transmitter is configured to periodically transmit the response information to the radio access network device according to the period information comprised in the received configuration information.

10. The equipment according to claim 8, wherein the transmitter is configured to transmit the response information to the radio access network device when the left amount of data cached in the buffer is less than or equal to the first threshold value or the time length for playing the left amount of data cached in the buffer is less than or equal to the second threshold value.

11. The equipment according to claim 8, wherein the transmitter is configured to transmit the response information to the radio access network device according to the indication information comprised in the received configuration information.

12. The equipment according to claim 8, wherein the configuration information is radio resource control connection re-configuration information, the response information is measurement report information.

13. A method for reporting status of a buffer, comprising:
determining, by a radio access network device, whether a rate at which a user equipment receives service data is lower than a rate at which the user equipment plays service data; and
increasing, by the radio access network device, resource for receiving downlink service data for the user equipment if it is determined that the rate at which the user equipment receives service data is lower than the rate at which the user equipment plays service data.

14. The method according to claim 13, further comprising:
in a circumstance that left amount of data cached in a buffer is less than or equal to a first threshold value or time length for playing left amount of data cached in a buffer is less than or equal to a second threshold value, increasing, by the radio access network device, resource for receiving downlink service data for the user equipment.

15. The method according to claim 14, wherein the increasing, by the radio access network device, the resource for receiving downlink service data for the user equipment, comprises:
increasing, by the radio access network device, the resource for receiving downlink service data for the user equipment by increasing resource of a source serving cell of the user equipment; or
increasing, by the radio access network device, the resource for receiving downlink service data for the user equipment by switching the user equipment from a source serving cell to a target cell.

16. The method according to claim 14, wherein before the increasing, by the radio access network device, the resource for receiving downlink service data for the user equipment, further comprising:
transmitting, by the radio access network device, configuration information to the user equipment, wherein the configuration information is used for indicating manner information of reporting left amount of data cached in a buffer or time length for playing left amount of data cached in a buffer by the user equipment; and
receiving, by the radio access network device, response information transmitted by the user equipment, wherein the response information is used for indicating the left amount of the data cached in the buffer or the time length for playing the left amount of the data cached in the buffer, which is reported by the user equipment.

17. The method according to claim 16, wherein the manner information is period information, threshold value information, or indication information, wherein the period information is used for indicating a period at which the user equipment reports the left amount of the data cached in the buffer or the time length for playing the left amount of the data cached in the buffer to the radio access network device, the threshold value information represents a first threshold value or a second threshold value, so that the user equipment determines to report the left amount of the data cached in the buffer to the radio access network device when the left amount of the data cached in the buffer is less than or equal to the first threshold value, or determines to report the left amount of the data cached in the buffer to the radio access network device when the time length for playing the left amount of the data cached in the buffer is less than or equal to the second threshold value, the indication information is used for indicating the user equipment to report the left amount of the data cached in the buffer or the time length for playing the left amount of the data cached in the buffer to the radio access network device.

18. The method according to claim 16, wherein the configuration information is radio resource control connection re-configuration information, the response information is measurement report information.
